(19) United States
(12) Patent Application Publication
(10) Pub. No.: US 2013/0115829 A1
(43) Pub. Date: May 9, 2013

(54) CONTACT MECHANISM, AND ELECTROMAGNETIC CONTACTOR USING THE CONTACT MECHANISM

(71) Applicants: Yasuhiro Naka, Kounosu-shi (JP); Kouetsu Takaya, Kounosu-shi (JP); Kenji Suzuki, Kounosu-shi (JP)

(72) Inventors: Yasuhiro Naka, Kounosu-shi (JP); Kouetsu Takaya, Kounosu-shi (JP); Kenji Suzuki, Kounosu-shi (JP)

(73) Assignee: FUJI ELECTRIC CO., LTD., Kawasaki-shi, Kanagawa (JP)

(21) Appl. No.: 13/640,917

(22) PCT Filed: Jun. 14, 2011
(86) PCT No.: PCT/JP2011/003377

§ 371 Date: Nov. 9, 2012

(30) Foreign Application Priority Data
Jul. 27, 2010 (JP) 2010-168177

(51) Int. Cl. H01H 50/54

(52) U.S. Cl. CPC H01H 50/54
USPC 439/883

(57) ABSTRACT

A contact mechanism includes a fixed contact and a movable contact adapted to be inserted in a conducting path. The fixed contact includes a pair of flat plate conductive bodies disposed and fixed to maintain a predetermined interval. The movable contact includes a flat plate conductive body disposed to face the pair of flat plate conductive bodies of the fixed contact and capable of contacting with and separating from the pair of flat plate conductive bodies. Current paths wherein each of the current paths has a current flowing in a same direction are formed at least two side portions of the flat plate conductive bodies of the fixed contact and movable contact mutually facing each other in a width direction.

### TECHNICAL FIELD

The present invention relates to a contact mechanism including a fixed contact and movable contact inserted in a current path, and to an electromagnetic contactor using the contact mechanism, wherein a Lorentz force is generated acting against an electromagnetic repulsion force that causes the movable contact to separate from the fixed contact when current is applied.

### BACKGROUND ART

As a contact mechanism that carries out an opening and closing of a current path, conventionally, for example, a circuit breaker, current limiter, or electromagnetic contactor, as a fixed contact applied to a switch wherein an arc is generated inside a receptacle when current is shut off, has been proposed, wherein a fixed contact is bent back in a U-shape from the side view, a fixed contact point is formed on the bent portion, and by arranging a movable contact point of a movable contact to contact with, and separate from, the fixed contact point, opening speed is increased by increasing an electromagnetic repulsion force acting on the movable contact when a large current is shut off, and the arc is swiftly drawn out (for example, refer to Patent Document 1).

### RELATED ART DOCUMENTS

### Patent Documents

Patent Literature 1: Japanese Patent Application Publication No. JP-A-2001-210170

### OUTLINE OF THE INVENTION

### Problems to be Solved by the Invention

However, with the heretofore known example described in Patent Document 1, the electromagnetic repulsion force generated is increased by the fixed contact in a U-shape when seen from the side, and by the large electromagnetic repulsion force, the opening speed of the movable contact at a time of shutting off a large current caused by a short circuit, or the like, is increased. The arc is drawn out swiftly, and it is possible to limit a fault current to a small value. In an electromagnetic contactor that handles a large current, however, as it is necessary to prevent the movable contact from opening due to the electromagnetic repulsion force when a large current is supplied, it is not possible to apply the heretofore known example described in Patent Document 1, and the need is generally addressed by increasing the spring force of a contact spring that ensures the contact pressure of the movable contact with respect to the fixed contact.

When increasing the contact pressure provided by the contact spring in this way, it is also necessary to increase thrust generated in the electromagnet driving the movable contact, and there is an unsolved problem in that the overall configuration increases in size.

Therefore, the invention, conceiving and focusing on the unsolved problem of the heretofore known example, has an object of providing a contact mechanism, and an electromagnetic contactor using the contact mechanism, wherein it is possible, with a flattened configuration wherein the thickness of a movable contact in the direction in which it can move is reduced, to suppress an electromagnetic repulsion force that causes the movable contact to open when a current is supplied.

### Means for Solving the Problems

In order to achieve the heretofore described object, a first aspect of a contact mechanism according to the invention is a contact mechanism including a fixed contact and movable contact inserted in a current path. The contact mechanism is such that the fixed contact includes a pair of flat plate conductive bodies disposed and fixed to maintain a predetermined interval. The movable contact includes a flat plate conductive body disposed to face the pair of flat plate conductive bodies of the fixed contact and capable of contacting with, and separating from, the pair of flat plate conductive bodies, and at least positions on both sides of the flat plate conductive bodies of the fixed contact and movable contact mutually facing each other in a width direction include current paths in which each of the current paths has a current flowing in a same direction.

According to this configuration, both the fixed contact and movable contact are formed as flattened flat plate conductive bodies and, by forming current paths through which current is caused to flow in the same direction in either width direction side of the flat plate conductive bodies, it is possible to suppress the opening of the movable contact by generating a Lorenz force in a direction to press the movable contact against the fixed contact when current is supplied.

Also, in a second aspect of the contact mechanism according to the invention, either one of the fixed contact or movable contact has portions on both sides of the flat plate conductive body in the width direction comprising U-shaped grooves forming the current paths penetrating from front to rear, and forming contact portions on plate portions bounded by the U-shaped grooves, and the other of the flat plate conductive body comprises through holes forming the current paths facing the current paths of the U-shaped grooves.

According to this configuration, current paths are formed by the U-shaped grooves in either width direction side of the flat plate conductive body of the fixed contact (or movable contact), current paths are formed by the through holes in either width direction side of the flat plate conductive body of the movable contact (or fixed contact), and due to a current flowing in the same direction through both sets of current paths, it is possible to suppress the opening of the movable contact by generating a Lorenz force that presses the movable contact against the fixed contact.

Also, in a third aspect of the contact mechanism according to the invention, a position toward an inner side of each of the pair of flat plate conductive bodies of the fixed contact has a U-shaped groove opened toward the inner side, and a fixed contact portion is formed on each plate portion bounded by the U-shaped groove. Both ends of the flat plate conductive body of the movable contact comprise a pair of movable contact portions facing the fixed contact portions, and inner sides of the pair of movable contact portions comprise through holes forming the current paths in width direction side.

According to this configuration too, by current paths mutually facing each other and through which current flows in the same direction being formed in both the fixed contact and movable contact, it is possible to suppress the opening of the movable contact by generating a Lorenz force that presses the movable contact against the fixed contact.

Also, in a fourth aspect of the contact mechanism according to the invention, a position on an inner side end portion of each of the pair of flat plate conductive bodies of the fixed contact comprises a fixed contact portion, and an outer side of each of the fixed contact portion comprises a through hole forming current paths on both sides in the width direction. Positions on the flat plate conductive body of the movable contact facing the fixed contact portions comprise U-shaped grooves opened outwardly, and movable contact portions facing the fixed contact portions are formed on plate portions bounded by the U-shaped grooves.

According to this configuration too, by current paths mutually facing each other and through which current flows in the same direction being formed in both the fixed contact and movable contact, it is possible to suppress the opening of the movable contact by generating a Lorenz force that presses the movable contact against the fixed contact.

Also, a first aspect of an electromagnetic contactor according to the invention includes the contact mechanism according to any one aspect of the first to fourth aspects, wherein the movable contact is coupled to a movable iron core of an operation electromagnet, and the fixed contact is connected to an external connection terminal.

According to this configuration, a Lorenz force is generated acting against an electromagnetic repulsion force that causes the movable contact and fixed contact to separate when current is supplied to the electromagnetic contactor, and it is thus possible to reduce the spring force of the contact spring that brings the movable contact into contact with the fixed contact. In accordance with this, it is also possible to reduce the thrust of the electromagnet that drives the movable contact, and it is thus possible to provide a compact electromagnetic contactor.

### Advantage of the Invention

According to the invention, the fixed contact and movable contact configuring the contact mechanism are both formed as flat plate conductive bodies, and it is possible to generate a Lorenz force acting against the opening direction electromagnetic repulsion force generated in the fixed contact and movable contact when a large current is supplied. Because of this, it is possible to reliably prevent the opening of the movable contact when a large current is supplied, without using a mechanical pressing force.

Also, by applying a contact mechanism having the heretofore described advantage to an electromagnetic contactor, it is possible to reliably prevent the movable contact from opening when a large current is supplied with a flattened contact mechanism in a closed condition, and it is thus possible to apply a compact electromagnetic contactor.

### BRIEF DESCRIPTION OF THE DRAWINGS

FIG. 1 is a cross-sectional view showing a first embodiment of a case in which the invention is applied to an electromagnetic contactor.

FIGS. 2(a)-2(d) are diagrams showing a first embodiment of a contact mechanism of the invention, wherein FIG. 2(a) is a perspective view, FIG. 2(b) is a cross-sectional view showing the contact mechanism when opened, FIG. 2(c) is a cross-sectional view showing the contact mechanism when closed, and FIG. 2(d) is a plan view showing current paths when closed.

FIGS. 3(a)-3(d) are diagrams showing a second embodiment of a contact mechanism of the invention, wherein FIG. 3(a) is a perspective view, FIG. 3(b) is a sectional view showing the contact mechanism when opened, FIG. 3(c) is a sectional view showing the contact mechanism when closed, and FIG. 3(d) is a plan view showing current paths when closed.

### MODE FOR CARRYING OUT THE INVENTION

Hereafter, a description will be given, based on the drawings, of embodiments of the invention.

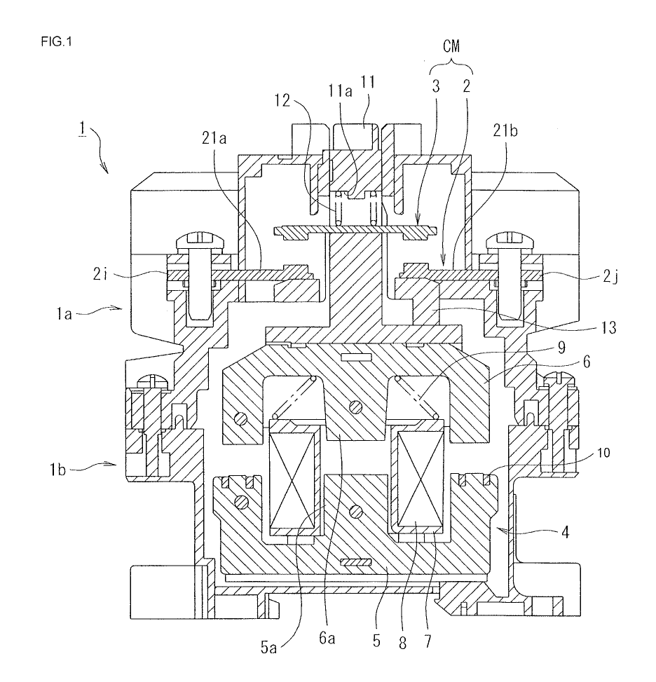

In FIG. 1, numeral 1 is a main body case made of, for example, a synthetic resin. The main body case 1 has a two-portion structure of an upper case 1a and a lower case 1b. A contact mechanism CM is installed in the upper case 1a. The contact mechanism CM includes a fixed contact 2 disposed fixed in the upper case 1a, and a movable contact 3 disposed to contact with, and separate from, the fixed contact 2.

Also, an operation electromagnet 4 that drives the movable contact 3 is disposed in the lower case 1b. The operation electromagnet 4 is such that a fixed iron core 5 formed of E-legged steel sheets and a movable iron core 6 formed in the same way of E-legged steel sheets are disposed facing each other.

An electromagnetic coil 8 to which a single phase current is supplied, wound in a coil holder 7, is fixed to a center leg portion 5a of the fixed iron core 5. Also, a return spring 9 that biases the movable iron core 6 in a direction away from the fixed iron core 5 is disposed between the upper surface of the coil holder 7 and a joint of a center leg portion 6a of the movable iron core 6.

Furthermore, a shading coil 10 is embedded in the upper end surfaces of outer side leg portions of the fixed iron core 5. Using the shading coil 10, it is possible to suppress a fluctuation in electromagnetic attraction force, noise, and vibration caused by a change in alternating magnetic flux in a single phase alternating current electromagnet.

Then, a contact holder 11 is coupled to the upper end of the movable iron core 6. In the contact holder 11, the movable contact 3 is pressed downward and held against the fixed contact 2 by a contact spring 12, so that a predetermined contact pressure is obtained, in an insertion hole 11a formed in a direction perpendicular to the axis in the upper end side of the contact holder 11.

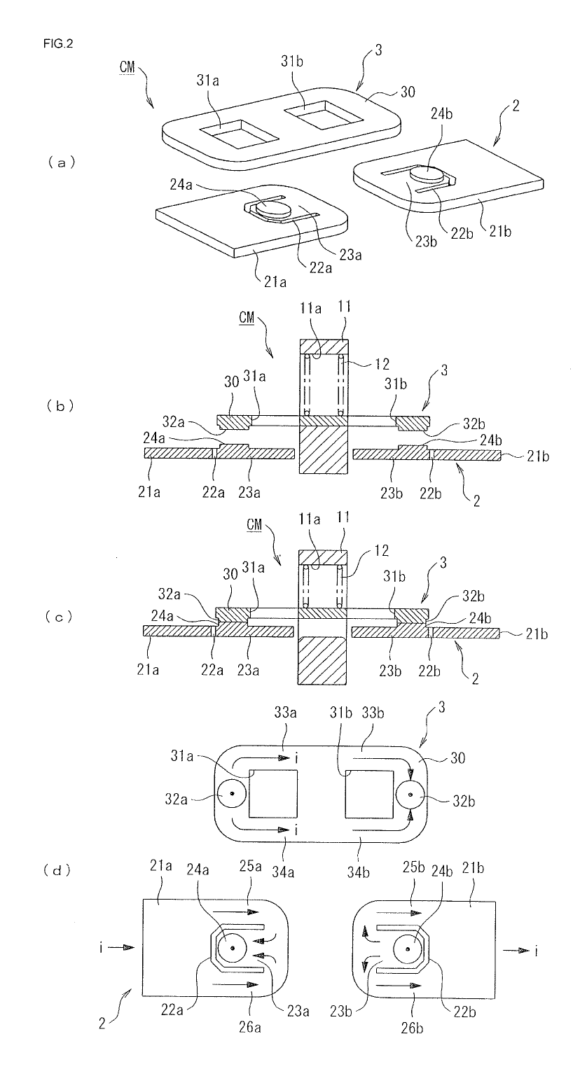

The fixed contact 2 and movable contact 3 configuring the contact mechanism CM are both formed in a flat plate form, as shown in FIGS. 2(a) to 2(c).

The fixed contact 2 has flat plate conductive bodies 21a and 21b of a rectangular form seen in planar view, disposed maintaining a predetermined interval between each other in a direction perpendicular to the direction in which the movable contact 3 can move. The flat plate conductive bodies 21a and 21b are formed to be axisymmetrical across a line passing centrally between the two, U-shaped grooves 22a and 22b whose opened end planes are on the inward end surface side are formed penetrating from front to rear in positions facing longitudinal direction end portions of the movable contact 3, and fixed contact portions 24a and 24b are formed on surfaces facing the movable contact 3 of plate portions 23a and 23b bounded by the U-shaped grooves 22a and 22b.

Meanwhile, the movable contact 3 is such that, as shown in FIGS. 2(a) to 2(c), square through holes 31a and 31b are formed separated from each other in positions in a flat plate conductive body 30 facing the plate portions 23a and 23b bounded by the U-shaped grooves 22a and 22b in the flat plate conductive bodies 21a and 21b of the fixed contact 2. A current path is formed by the through holes 31a and 31b in either side in the width direction of the flat plate conductive body 30. Also, movable contact portions 32a and 32b are formed on the lower surfaces of the end portions on the outer side of each of the through holes 31a and 31b facing the fixed contact portions 24a and 24b of the fixed contact 2.

Next, a description will be given of an operation of the heretofore described first embodiment.

Now, when the electromagnetic coil 8 of the operation electromagnet 4 is in a non-conductive condition, no attraction force is generated between the fixed iron core 5 and movable iron core, and the movable iron core 6 is in an upper position due to the return spring 9. Because of this, as the contact holder 11 is in an upper position, as shown in FIG. 2(b), the flat plate conductive bodies 21a and 21b of the fixed contact 2 and the movable contact 3 are separated, both of the fixed contact portions 24a and 24b and the movable contact portions 32a and 32b are separated, and the contact mechanism CM is in an opened condition.

When a single phase alternating current is supplied to the electromagnetic coil 8 of the operation electromagnet 4 with the contact mechanism CM in the opened condition, the contact holder 11 descends due to the movable iron core 6 being attracted to the fixed iron core 5 against the force of the return spring 9, the fixed contact portions 24a and 24b of the fixed contact 2 and the movable contact portions 32a and 32b of the movable contact 3 of the contact mechanism CM contact, and the contact mechanism CM takes on a closed condition.

With the contact mechanism CM in the closed condition, a large current from, for example, a direct current power source, input from an external connection terminal 2i is input into the left end side of the flat plate conductive body 21a and, as the fixed contact portion 24a is formed in the plate portion 23a bounded by the U-shaped groove 22a, the large current input into the flat plate conductive body 21a enters the plate portion 23a via current paths 25a and 26a on either side surface side of the U-shaped groove 22a, and is supplied from the fixed contact portion 24a to the movable contact portion 32a of the movable contact 3, as shown in FIG. 2(d).

The large current supplied to the movable contact portion 32a passes through current paths 33a and 34a on either side surface side of the through hole 31a, passes through current paths 33b and 34b on either side surface side of the through hole 31b, and is supplied from the movable contact portion 32b to the fixed contact portion 24b of the flat plate conductive body 21b.

The large current supplied to the fixed contact portion 24b passes from the plate portion 23b through current paths 25b and 26b on either side surface side of the U-shaped groove 22b, passes from the right end side of the flat plate conductive body 21a through an external connection terminal 2j, and is supplied to a load.

At this time, the directions of the currents passing through the current paths 25a and 26a of the flat plate conductive body 21a of the fixed contact 2 mutually facing each other and current paths 33a and 34a of the movable contact 3 are the same, and in the same way, the directions of the currents passing through the current paths 33b and 34b of the movable contact 3 mutually facing each other and current paths 25b and 26b of the flat plate conductive body 21b of the fixed contact 2 are the same.

Because of this, a downward Lorentz force is generated in accordance with Fleming's left-hand rule in the current paths 33a and 34a, and 33b and 34b, of the movable contact 3. Because of the Lorentz force, it is possible to suppress an opening direction electromagnetic repulsion force generated between the fixed contact portions 24a and 24b and movable contact portions 32a and 32b, and thus possible to prevent the movable contact 3 from opening.

Consequently, even when an electromagnetic repulsion force is generated in the direction in which the movable contact 3 is opened, it is possible to generate a Lorentz force acting against the electromagnetic repulsion force in the fixed contact 2 and movable contact 3; therefore, possible to reliably suppress the opening of the movable contact 3. Because of this, it is possible to reduce the pressing force of the contact spring 12 supporting the movable contact 3, in accordance with which it is also possible to reduce thrust generated in the operation electromagnet 4, and it is thus possible to reduce the size of the overall configuration of the electromagnetic contactor.

Moreover, in this case, the fixed contact 2 and movable contact 3 are both configured to have the flattened flat plate conductive bodies 21a, 21b, and 30, and simply by forming current paths through which currents are caused to flow in the same direction in either width direction side of the flat plate conductive bodies 21a, 21b, and 30 mutually facing each other, it is possible to generate a Lorentz force that presses the movable contact 3 to the fixed contact 2 side, and thus possible to reduce the thickness in the direction in which the movable contact 3 can move of the fixed contact 2 and movable contact 3 configuring the contact mechanism CM.

Also, as it is possible to easily carry out the processing of the fixed contact 2 and movable contact 3, and there is no need for another, separate member that generates an electromagnetic force or mechanical force acting against the opening direction electromagnetic repulsion force, there is no increase in the number of parts, and it is possible to prevent the overall configuration from increasing in size.

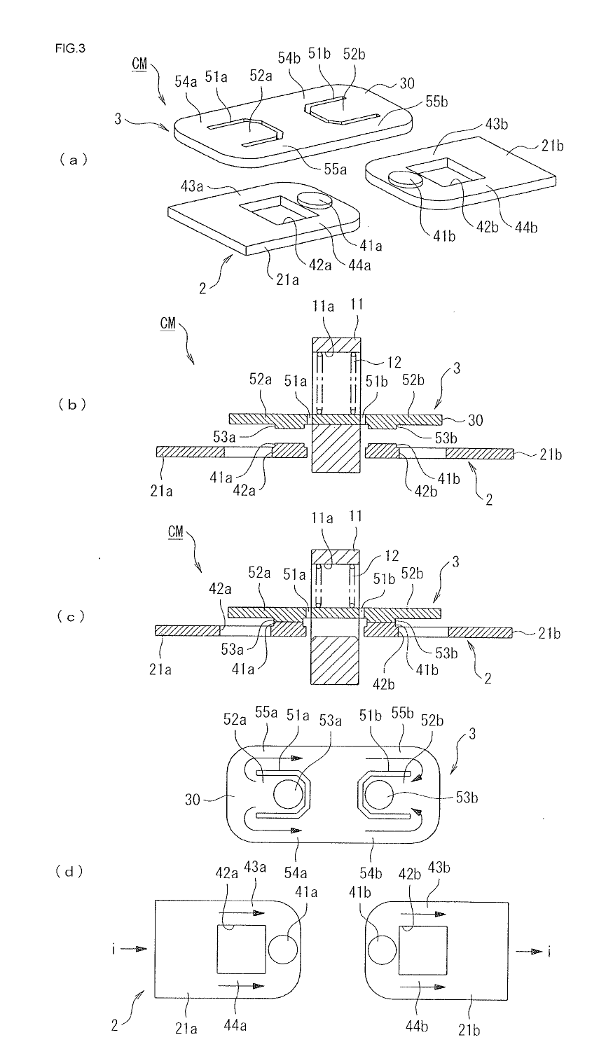

Next, a description will be given, based on FIG. 3, of a second embodiment of the invention.

In the second embodiment, through holes are formed in the fixed contact, and U-shaped grooves are formed in the movable contact.

That is, in the second embodiment, by fixed contact portions 41a and 41b being formed on end surface sides of the flat plate conductive bodies 21a and 21b of the fixed contact 2 mutually facing each other, and square through holes 42a and 42b being formed on the outer sides of the fixed contact portions 41a and 41b, current paths 43a, 44a, 43b, and 44b are formed on either width direction side of the flat plate conductive bodies 21a and 21b, as shown in FIGS. 3(a) to 3(d).

Meanwhile, in the movable contact 3, U-shaped grooves 51a and 51b whose opened end portions are on the outer side are formed penetrating from front to rear in positions in the flat plate conductive body 30 facing the fixed contact portions 41a and 41b of the fixed contact 2, and movable contact portions 53a and 53b facing the fixed contact portions 41a and 41b are formed on plate portions 52a and 52b bounded by the U-shaped grooves 51a and 51b. Then, current paths 54a, 55a, 54b, and 55b are formed in either side portion forming the width direction outer sides of the U-shaped grooves 51a and 51b.

According to the second embodiment, in a condition in which the electromagnetic coil 8 of the operation electromagnet 4 is in a non-conductive condition, the contact holder 11 has risen to an upper position, in the same way as in the first embodiment, the movable contact 3 is separated on the upper side from the fixed contact 2, and the contact mechanism CM is in an opened condition, as shown in FIG. 3(b).

When a single phase alternating current is supplied to the electromagnetic coil 8 of the operation electromagnet 4 with the contact mechanism CM in the opened condition, the movable iron core 6 is attracted by the fixed iron core 5 against the force of the return spring 9. Because of this, the contact holder 11 descends, the movable contact portions 53a and 53b of the movable contact 3 contact with the fixed contact portions 41a and 41b of the fixed contact 2 at the contact pressure of the contact spring 12, and the contact mechanism CM takes on a closed condition, as shown in FIG. 3(c).

With the contact mechanism CM in the closed condition, a large current i input from the external connection terminal 2i is supplied to the flat plate conductive body 21a of the fixed contact 2 from the left side as shown in FIG. 3(d). The large current i supplied to the flat plate conductive body 21a passes through the current paths 43a and 44a on either width direction side of the through hole 42a, and is supplied from the fixed contact portion 41a to the movable contact portion 53a of the movable contact 3.

In the movable contact 3, the large current i supplied from the movable contact portion 53a passes from the plate portion 52a through the current paths 54a and 55a on either width direction side of the U-shaped groove 51a, further passes through the current paths 54b and 55b on either width direction side of the U-shaped groove 51b, passes from the plate portion 52b through the movable contact portion 53b, and is supplied to the fixed contact portion 41b of the flat plate conductive body 21b of the fixed contact 2.

The large current i supplied to the fixed contact portion 41b passes through the current paths 43b and 44b on either width direction side of the through hole 42b, and is supplied from the external connection terminal 2j to a load (not shown).

Because of this, the large current i flowing through the current paths 43a, 44a, 43b, and 44b of the flat plate conductive bodies 21a and 21b of the fixed contact 2 and the large current i flowing through the current paths 54a, 55a, 54b, and 55b of the movable contact 3 facing the current paths 43a, 44a, 43b, and 44b have the same direction. Because of this, in the same way as in the first embodiment, a Lorentz force is generated, pressing the movable contact 3 to the fixed contact 2 side against an electromagnetic repulsion force generated between the fixed contact 2 and movable contact 3. Consequently, in the same way as in the first embodiment, it is possible to reliably suppress the opening of the movable contact 3. Because of this, it is possible to reduce the pressing force of the contact spring 12 supporting the movable contact 3, in accordance with which it is also possible to reduce thrust generated in the operation electromagnet 4, and it is thus possible to reduce the size of the overall configuration of the electromagnetic contactor.

Moreover, in this case, the fixed contact 2 and movable contact 3 are both configured of the flattened flat plate conductive bodies 21a, 21b, and 30, and simply by forming current paths through which currents are caused to flow in the same direction in either width direction side of the flat plate conductive bodies 21a, 21b, and 30 mutually facing each other, it is possible to generate a Lorentz force that presses the movable contact 3 to the fixed contact 2 side, and thus possible to reduce the thickness in the direction in which the movable contact 3 can move of the fixed contact 2 and movable contact 3 configuring the contact mechanism CM.

Also, as it is possible to easily carry out the processing of the fixed contact 2 and movable contact 3, and there is no need for another, separate member that generates an electromagnetic force or mechanical force acting against the opening direction electromagnetic repulsion force, there is no increase in the number of parts, and it is possible to prevent the overall configuration from increasing in size.

In the first and second embodiments, a description has been given of a case in which the fixed contact 2 and movable contact 3 are configured of the flat plate conductive bodies 21a, 21b, and 30, which are rectangular when seen in planar view, but, not being limited to this, it is possible to form the fixed contact 2 and movable contact 3 in a parallelogram form, or to form them in an elliptical form.

Also, the current paths formed in the fixed contact 2 and movable contact 3 too, not being limited to the case in which they are of a linear form, can be of an arc form or wave form, that is, it is sufficient that plural current paths mutually facing each other are formed in the fixed contact 2 and movable contact 3, and that current is caused to flow in the same direction through each current path.

Furthermore, the insides of the U-shaped grooves 22a, 22b, 51a, and 51b may be filled with an insulating material.

Also, in the first and second embodiments, a description has been given of a case in which the operation electromagnet 4 is energized with an alternating current, but an operation electromagnet energized with a direct current may also be applied, and furthermore, the drive mechanism of the movable contact 3 not being limited to the heretofore described configuration, it is possible to apply a drive mechanism of any configuration.

Also, the contact mechanism CM according to the invention not being limited to the case in which it is applied to an electromagnetic contactor, it can be applied to any other instrument such as a switch.

### INDUSTRIAL APPLICABILITY

The invention provides a contact mechanism, and an electromagnetic contactor using the contact mechanism, wherein both a fixed contact and movable contact are formed as flat plate conductive bodies, a Lorenz force is generated acting against an opening direction electromagnetic repulsion force generated in the fixed contact and movable contact when a large current is supplied, and it is thus possible to suppress opening when a large current is supplied.

### DESCRIPTION OF REFERENCE NUMERALS AND SIGNS

1 . . . Main body case, 1a . . . Upper portion case, 1b . . . Lower portion case, 2 . . . Fixed contact, 2i, 2j . . . External connection terminal, 3 . . . Movable contact, 4 . . . Operation electromagnet, 5 . . . Fixed iron core, 6 . . . Movable iron core, 8 . . . Electromagnetic coil, 9 . . . Return spring, 11 . . . Contact holder, 12 . . . Contact spring, 13 . . . Stopper, 21a, 21b . . . Flat plate conductive body, 22a, 22b U-shaped groove, 23a, 23b . . . Plate portion, 24a, 24b . . . Fixed contact portion, 25a, 25b, 26a, 26b . . . Current path, 30 . . . Flat plate conductive body, 31a, 31b . . . Through hole, 32a, 32b . . . Fixed contact portion, 33a, 33b, 34a, 34b . . . Current path, 41a, 41b . . . Fixed contact portion, 42a, 42b . . . Through hole, 43a, 43b, 44a, 44b . . . Current path, 51a, 51b . . . U-shaped groove, 52a, 52b . . . Plate portion, 53a, 53b . . . Movable contact portion, 54a, 54b, 55a, 55b . . . Current path

1. A contact mechanism, comprising a fixed contact and a movable contact adapted to be inserted in a conducting path,
wherein the fixed contact includes a pair of flat plate conductive bodies disposed and fixed to maintain a predetermined interval,
the movable contact includes a flat plate conductive body disposed to face the pair of flat plate conductive bodies of the fixed contact and capable of contacting with and separating from the pair of flat plate conductive bodies, and
current paths wherein each of the current paths has a current flowing in a same direction are formed at least two side portions of the flat plate conductive bodies of the fixed contact and movable contact mutually facing each other in a width direction.

2. A contact mechanism according to claim 1, wherein a U-shaped groove forming the current path at two side portions in the width direction of the flat plate conductive body and penetrating from front to rear of the conductive body is formed in either one of the fixed contact or movable contact, and a contact portion is formed on the conductive body bounded by the U-shaped groove, and
a through hole forming the current path facing the current path of the U-shaped grooves is formed at the other of the flat plate conductive body of the fixed contact or movable contact.

3. A contact mechanism according to claim 1, wherein a U-shaped groove opened at an inner side is formed at a position toward the inner side of each of the pair of flat plate conductive bodies of the fixed contact, and a fixed contact portion is formed on each flat plate conductive body bounded by the U-shaped groove, and
a pair of movable contact portions facing the fixed contact portions is formed at two ends of the flat plate conductive body of the movable contact, and through holes forming the current paths are formed in a width direction side at inner sides of the pair of movable contact portions.

4. A contact mechanism according to claim 1, wherein a fixed contact is formed at a position on an inner side end portion of each of the pair of flat plate conductive bodies of the fixed contact, and a through hole forming current paths on two sides in the width direction is formed at an outer side of each of the fixed contact portion, and
U-shaped grooves opened outwardly is formed at positions on the flat plate conductive body of the movable contact facing the fixed contact portions, and movable contact portions facing the fixed contact portions are formed on plate portions bounded by the U-shaped grooves.

5. An electromagnetic contactor comprising the contact mechanism according to claim 1, wherein the movable contact is coupled to a movable core of an operation electromagnet, and the fixed contact is connected to an external connection terminal.
